(19) United States
(12) Patent Application Publication
(10) Pub. No.: US 2015/0304711 A1
(43) Pub. Date: Oct. 22, 2015

(54) METHOD AND DEVICE FOR SELECTING A DESIRABLE CHANNEL WHEN POWERED-ON

(71) Applicant: THOMSON LICENSING, Issy-Les-Moulineaux (FR)

(72) Inventors: Zhigang ZHANG, Beijing (CN); Yuntao SHI, Beijing (CN); YanFeng Zhang, Beijing (CN)

(21) Appl. No.: 14/648,257

(22) PCT Filed: Nov. 30, 2012
(86) PCT No.: PCT/CN2012/085626

§ 371 Date: May 28, 2015

(51) Int. Cl. H04N 21/443; H04N 21/442; H04N 21/438

(52) U.S. Cl. CPC H04N 21/4432; H04N 21/4383; H04N 21/44222

(57) ABSTRACT

The present invention relates to a method for selecting desirable channel when powered-on. The method comprises storing data of the start viewing time, the stop viewing time, and the channel of a program a user views as a user's viewing history table; selecting a start channel when powered-on from a plurality of channels corresponding to broadcast signals; receiving an input signal corresponding to the start channel selected by the channel selecting means; wherein, when powered-on, if current time falls in the viewing period from the start viewing time to the stop viewing time starting from the latest entry on the user's viewing history table, the channel selecting means selects the channel corresponding to the matching viewing period as a start channel, and if it does not, the channel selecting means selects a corresponding channel whose start time has the shortest distance with the current time and is the latest entry on the user's viewing history table.

### FIELD OF THE INVENTION

The present invention relates to a method and device for selecting a desirable channel when powered-on. More particularly, the present invention relates to a method and device for selecting a desirable channel for a user on the basis of a log table.

### BACKGROUND OF THE INVENTION

In a typical in-home entertainment system environment, STB (Set Top Box) is an indispensable element that receives and selects broadcast signals, decodes and decompresses media signals, and then converts them into a form that can be used by a television.

As soon as being installed at a home, every STB needs to start a channel scan process that scans through the TV channel frequency band and stores the radio frequency, channel number, and name for all available TV channels onto the local disk. After the initial setup process, a TV user can press the number key in the STB's remote controller to input the corresponding TV channel number for the channel the user wants to view, then the STB finds the matching radio frequency for the channel, tunes the RF (radio frequency) receiver to the specific frequency and demodulates the channel, separates off the channel into its component control and media parts, decodes the compressed digital video and audio data, and then converts the uncompressed digital media into a format that can be played on television.

Further, when a user powers on an STB and television to view TV, usually the STB retrieves the TV channel that was the last channel viewed before the STB was powered off last time, tunes into the corresponding frequency, receives the media signals, and then sends them to TV set for rendering. Another alternative feature is that the user can select a “custom powered-on” option on the TV menu, and choose the “always powered-on to a single channel” sub-option, and input a specific channel number. Then after being powered on next time, the STB automatically tunes in to the defined TV channel and shows the content from the channel on the television.

However, these options available for automatic TV channel selection in current STB, either “powered-on to the last channel viewed” or “always powered-on to a single channel”, fix the TV channel selection when the TV and STB is powered on next time and the channel cannot be flexibly adjusted according to the user's changing TV view preferences. As an example, a simple scenario is explained in which a user selects multiple channels to view during a TV viewing session took into consideration. For instance, a user chooses CCTV to view nightly news from 19:00 to 19:30; then the user chooses HNTV to view “Desperate Housewives” series from 19:40 to 21:00; finally the user chooses DFTV to view “Talent show” from 21:00 to 22:00. If the default “powered-on to the last channel” option is selected, when the user, with the aim of viewing CCTV, powers on the STB and TV at 19:00 the next night, the STB will tune into the DFTV, which is the last channel viewed before, and show the corresponding program on TV instead. On the other hand, if the “always powered-on to a single channel” option is selected and the user sets the default TV channel as CCTV, when the user, with the aim of viewing “Desperate Housewives” on HNTV, powers on the STB and TV at 20:00 the next night, the STB will tune into CCTV and show the corresponding program on CCTV on the TV instead. Apparently, under the above circumstance, both the two channel selection options do not match into a user's viewing habits and expectation, and cause inevitably a bad user experience.

By proposing an intelligent channel selection functionality based on the analysis of a user's viewing history and the current time context, the present invention solves the problem that the current automatic TV channel selection methods after powered-on, that is, either the “powered-on to the last channel viewed” method or the “always powered-on to a single channel” method, cause a bad user experience by choosing TV channel which fails to meet the user's viewing expectation.

As related art, JP04538722B2 discloses a method for automatically tuning a channel to be the one which is most desired by a user when powered-on.

### SUMMARY OF THE INVENTION

It is reasonable to assume that a user's TV viewing tendencies in the future can be deduced from the same person's viewing history in the past. Based on this foundation, the present invention proposes a solution to track a user's TV viewing history by recording the TV channel he viewed, and the start viewing time and stop viewing time for the channel. Thus, an intelligent TV channel selection functionality has been proposed to automatically choose a TV channel by detecting the viewer's viewing expectation based on the user's viewing habits, analyzed from a log table, and the user's context, as indicated by the current viewing time.

According to an aspect of the present invention, there is provided a method for selecting an desirable channel when powered-on. The devise comprises channel selecting means for selecting a start channel when powered-on from a plurality of channels corresponding to broadcast signals; receiving means for receiving input signals corresponding to the start channel selected by the channel selecting means; storage means for storing data of a start viewing time, a stop viewing time, and a channel of a program a user views as a user's viewing history table during powered-on, if the viewing duration between the start viewing time and stop viewing time is not less than a predetermined threshold; wherein, when powered-on, if the current time falls in the viewing duration starting from the latest entry of the user's viewing history table, the channel selecting means selects the channel corresponding to the matched viewing period as a start channel, and if it does not, the channel selecting means selects a corresponding channel whose start time is closest to the current time and is the latest entry of the user's viewing history table.

According to another aspect of the present invention, there is provided a device for selecting a desirable channel when powered-on. The device comprises means for storing data of a start viewing time, a stop viewing time, and a channel of a program a user views as a user's viewing history table during powered-on, if the viewing duration between the start viewing time and stop viewing time is not less than a predetermined threshold; selecting a start channel when powered-on from a plurality of channels corresponding to broadcast signals; receiving input signals corresponding to the start channel selected by the channel selecting means; wherein, when powered-on, if the current time falls in the viewing duration starting from the latest entry of the user's viewing history table, the channel selecting means selects the corresponding channel to the matched viewing period as a start channel, and if it does not, the channel selecting means selects a corresponding channel whose start time that is closest to the current time and is the latest entry of the user's viewing history table.

### BRIEF DESCRIPTION OF DRAWINGS

These and other aspects, features and advantages of the present invention will become apparent from the following description in connection with the accompanying drawings in which:

FIG. 1 is an exemplary block diagram illustrating a device in accordance with the invention and peripheral devices;

FIG. 2 is an exemplary flow chart illustrating the TV viewing history logging application's workflow; and

FIG. 3 is an exemplary flow chart illustrating the intelligent channel selection application's workflow.

### DETAILED DESCRIPTION OF PREFERRED EMBODIMENTS

In the following description, various aspects of an embodiment of the present invention will be described. For the purpose of explanation, specific configurations and details are set forth in order to provide a thorough understanding. However, it will also be apparent to one skilled in the art that the present invention may be implemented without the specific details present herein.

To solve the problem that after powered-on the current automatic TV channel selection methods, either of the “powered-on to the last channel viewed” method or the “always powered-on to a single channel” method, cause a bad user experience by choosing a TV channel that fails to meet the user's viewing expectation, the present invention proposes an intelligent channel selection functionality after TV powered-on. First, in addition to the default “powered-on to the last channel viewed” sub-option and “powered-on to a single channel” sub-option in the “custom powered-on” option in a TV setting menu, it is proposed to add an “intelligent channel selection after powered-on” sub-option to the “custom powered-on” option. Then a user can use a remote control to select the “intelligent channel selection after powered-on” sub-option to enable the intelligent channel selection functionality, while cancel the “intelligent channel selection after powered-on” sub-option to disable the intelligent channel selection functionality.

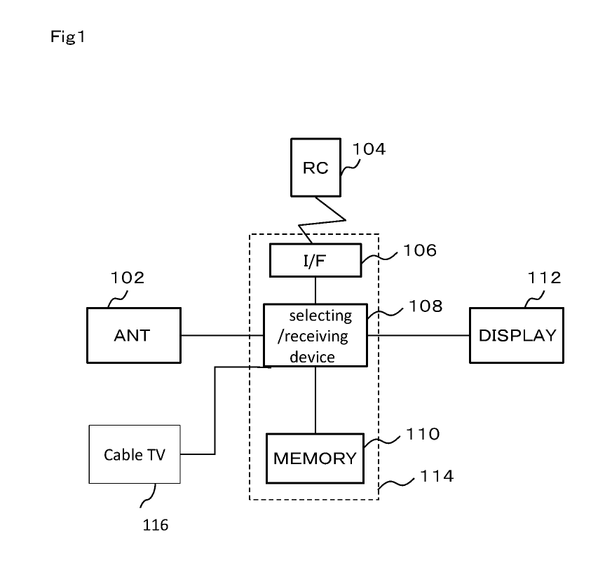

FIG. 1 is an exemplary block diagram illustrating a device in accordance with the invention and peripheral devices. An antenna 102 receives broadcast signals, and a selecting/receiving device 108 selects a start channel when a user powers on set top box 114 on the basis of a user's viewing history table stored in a memory 110. In other words, a selecting/receiving device 108 provides the intelligent channel selection functionality. The selecting/receiving device 108 receives input signals corresponding to the selected start channel, converts the signals into video and audio signals, and sends them to a display 112. Then the display 112 outputs the video and audio signals. A user can send commands to the selecting/receiving device 108 through an interface 106 using a remote controller 104. The STB 114 comprises the interface 106, the selecting/receiving device 108, and the memory 110. The STB 114 receives the input signals through an input terminal.

As soon as the intelligent channel selection functionality is enabled by a user, a corresponding user viewing history logging application on the STB 114 is started to monitor the user's viewing history and record it to the user viewing history table in memory 110. The application will stop working after the STB 114 is powered off and start to work as soon as the STB 114 is powered on next time unless the intelligent channel selection functionality is disabled by a user.

During the user viewing history logging application's working life cycle, every time that the STB 114 receives a channel selection command from the remote controller 104 and switches the channel accordingly, the application will be notified and then record the previous channel's name (i.e., the name of the channel which has been switched from), the current channel's name (i.e. the name of the channel which has been switched to) and the switching time (i.e. the actual time and date on the STB 114 when the channel switch occurred). Then, the application uses the switching time as the stop viewing time for the previous channel, and then infers the duration for which the previous channel has been viewed by calculating the difference between the stop viewing time for the channel and the start viewing time for the same channel. Meanwhile, the application uses the switching time as the start viewing time for the current channel. Next time when a channel switch occurs again, the application will record the actual time and date on the STB 114 at that time as the same channel's stop viewing time and then infer the duration for which the same channel is being viewed by calculating the difference between the stop viewing time and the start viewing time for the channel. If the viewing duration for a channel is less than a predetermined threshold, for instance, one minute, which indicates that the specific channel has been viewed for a short time, the channel's related information, such as channel name, start viewing time, and the stop viewing time and start viewing date information, will not be stored in a TV viewing history table. Otherwise, an entry which records the TV channel name, start viewing time, stop viewing time and start viewing date will be stored in a TV viewing history table. So, as long as the application is working, the TV channel viewing history will be continuously recorded in the TV viewing history table. Further, the entries in the TV viewing history table that reflect the viewing experience before a predetermined date, for instance, 10 days ago, will be deleted so that the records reflect the latest viewing habits of the viewer. An example a TV viewing history table is illustrated below Table-1:

TABLE 1
TV viewing history table sample

| | Channel | Start | Stop | Start |
|---|---|---|---|---|
| ID | name | time | time | Date |
| 1 | DFTV | 21:00 | 22:00 | Jun 8 |
| 2 | HNTV | 19:40 | 21:00 | Jun 8 |
| 3 | CCTV | 19:00 | 19:30 | Jun 8 |
| 4 | SDTV | 19:44 | 20:30 | Jun 7 |
| 5 | CDTV | 19:00 | 19:30 | Jun 7 |
| 6 | AHTV | 20:00 | 21:00 | Jun 6 |

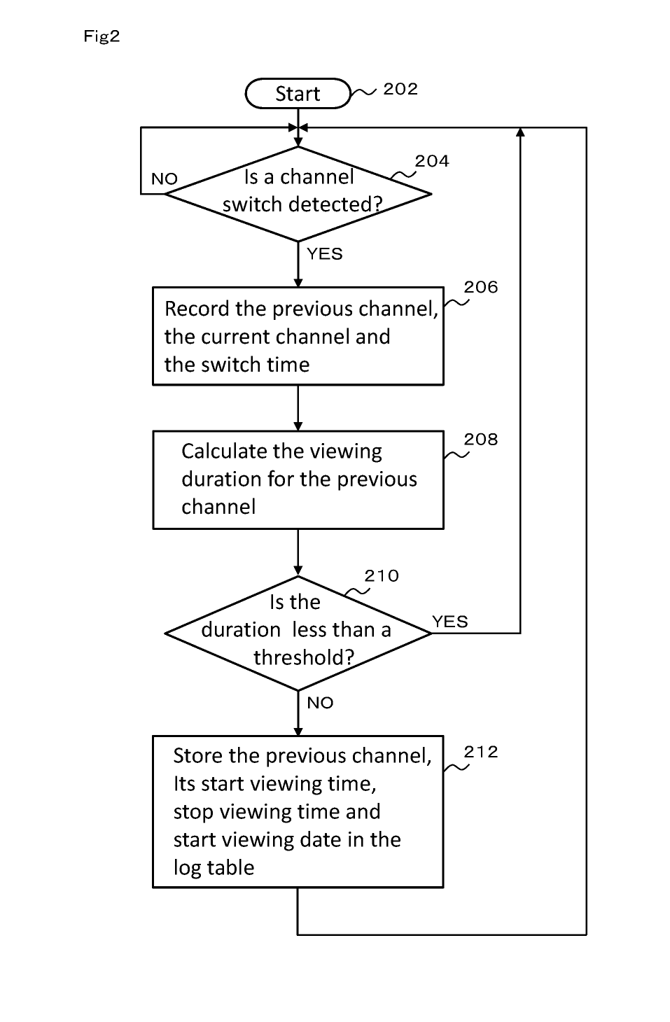

Meanwhile, a flow chart illustrating the TV viewing history logging application's workflow is shown in FIG. 2.

While the user's viewing history logging application on the STB 114 is activated, the STB 114 detects a channel switch by the user at step 204. If a channel switch detected, the STB 114 records the previous channel, the current channel, and the switch time in memory 110 at step 206. Then the STB 114 calculates the viewing duration for the previous channel at step 208. At step 210, the STB determines whether the duration is less than a threshold or not. If the duration is less than the threshold, the duration is not stored in the log table; and step 210 returns to step 204. If the duration is equal to or more than the threshold, the previous channel, its start viewing time, stop viewing time, and start viewing date are stored in the log table in the memory 110 at step 212.

On the other hand, as soon as the STB 114 is powered on, it will detect whether or not the intelligent channel selection functionality has been enabled by a user. If yes, a corresponding intelligent channel selection application will be initiated to determine the best TV channel for the viewer based on the current time context and the TV viewing history. At first, the application will obtain the local time, in terms of hour and minute, from the clock in the STB 114. Then, the application will compare the current time with the start time and stop time for every viewing history entry in the TV viewing history table, starting from the latest record, to determine whether there is an entry for which the current powered-on time falls in the period which starts from the entry's start time and ends at the entry's stop time. As soon as an entry meeting the criteria is found, the application will stop the searching process immediately, retrieve the channel name for the specific entry and instruct the STB to tune to the specific channel. For instance, if the current powered-on time and date is 20:00 and Jun 9 respectively, then the latest entry meeting the criteria in the above sample table is the entry with the identification number 2, for which the current time 20:00 lies between its start time 19:40 and stop time 21:00. So the STB will tune to the corresponding channel for entry 2: HNTV. On the contrary, if there is no matching entry found that meets the criteria, the application will compare the current powered-on time with the start time of every entry in the table, starting from the latest record, to find the entry which has the smallest distance between the current powered-on time and its start time, and then tune to the matching entry's channel. For instance, if the current powered-on time and date is 19:35 and Jun 9 respectively, the entry meeting the above criteria is the entry with identification number 2, because the distance between the current time 19:35 and the entry's start time 19:40 is the smallest one when compared with other distances. So the STB will tune to the corresponding channel for entry 2: HNTV. Furthermore, if there is more than one matching entry that has the same smallest distance, the latest entry will be selected and then the STB will tune to the corresponding channel for the specific entry. For instance, if the current powered-on time and date is 18:50 and Jun 9 respectively, there are two entries which have the smallest distance, entry 3 and entry 5, and then the entry 3 will be selected because its start date, Jun 8, is the latest when compared with the start date for entry 5, Jun 7. So the STB 114 will tune to the corresponding channel for entry 3: CCTV.

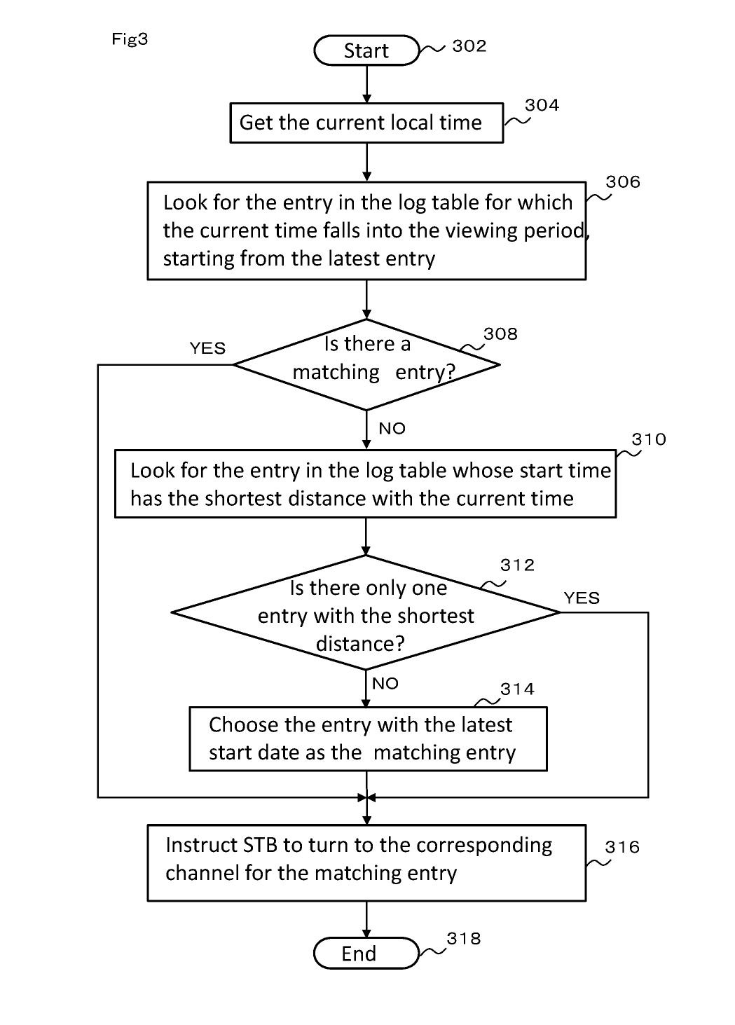

A flow chart illustrating workflow of the intelligent channel selection application is shown in FIG. 3. As soon as a user powers on the STB 114 on which the intelligent channel selection application on the STB 114 is activated, the STB 114 gets the current local time at step 304. Then the selecting/receiving device 108 of the STB 114 looks for the entry in the log table for which the current time falls into the viewing period, starting from the latest entry at step 306. If there is a matching entry, a selecting/receiving device 108 receives input signals corresponding to the selected start channel, converts the signals into video and audio signals, and sends them into a display 112 at step 316. If there is not a matching entry, the selecting/receiving device 108 looks for the entry in the log table whose start time has the shortest distance with the current time at step 310. If there is only one entry with the shortest distance, then selecting/receiving device 108 receives input signals corresponding to the selected start channel, converts the signals into video and audio signals, and sends them into a display 112 at step 316. If there is not only one entry with the shortest distance, the selecting/receiving device 108 chooses the entry with the latest start date as the matching entry at step 314. Then selecting/receiving device 108 receives input signals corresponding to the selected start channel, converts the signals into video and audio signals, and sends them into a display 112 at step 316.

Moreover, the intelligent channel selection application may also be utilized to help a viewer to automatically switch to a favorite channel once he initiates a channel switch command with a remote control. For instance, the above intelligent channel selection application may be initiated once a next channel command, which is a viewer command to proceed to the next channel by using the channel up/down buttons on a remote control, is received at STB side. Then, the STB will initiate the intelligent channel selection process described above to find the best channel by analyzing the context of the current viewing time and the viewer's viewing history table, instead of just tuning to the channel whose number is larger/smaller in comparison to the number of the current channel.

A possible extension to the proposed idea of intelligently select TV channel based on the viewing history and time context is to add more features of the viewing context to the viewing history table, such as program names and genres, extracted from the meta-data associated with the viewed TV program, and weekday information. Based on the extension, an example TV viewing history table, which contains these features, is illustrated below Table-2:

TABLE 2
TV viewing history table with more value-added features

| | Channel | Start | Stop | Start | Week | Program | Program | Program |
|---|---|---|---|---|---|---|---|---|
| ID | name | time | time | Date | day | name | genres | stars |
| 1 | DFTV | 21:00 | 22:00 | Jun 8 | Wed. | The | Drama, | Britt |
| | | | | | | secret | Fantasy | Roberson, |
| | | | | | | circle | | Thomas |
| | | | | | | | | Dekker |
| 2 | HNTV | 19:40 | 21:00 | Jun 8 | Wed. | Person of | Drama, | Jim |
| | | | | | | Interest | Thriller | Caviezel, |
| | | | | | | | | Kevin |
| | | | | | | | | Chapman |
| 3 | CCTV | 19:00 | 19:30 | Jun 8 | Wed. | National | News | Zhang |
| | | | | | | News | | Hong, Li |
| | | | | | | | | Ying |
| 4 | SDTV | 19:44 | 20:30 | Jun 7 | Tue. | Family | Animation, | Seth |
| | | | | | | Guy | Comedy | MacFarlane, |
| | | | | | | | | Alex |
| | | | | | | | | Borstein |
| 5 | CDTV | 19:00 | 19:30 | Jun 7 | Tue. | Local | News | Wang |
| | | | | | | News | | Dong, He |
| | | | | | | | | Xia |
| 6 | AHTV | 20:00 | 21:00 | Jun 6 | Mon. | The Big | Comedy | Johnny |
| | | | | | | Bang | | Galecki, |
| | | | | | | Theory | | Jim |
| | | | | | | | | Parsons |

It is proposed to create a training set based on the previous viewing history data by using the value-added features in the above table. Then we can use the training set to train an intelligent selection algorithm based on any recommendation algorithms in machine learning field, for example, decision trees and a SVM (Support Vector Machine). Subsequently, when a user powers on a STB or starts to select a channel, our solution can automatically extract the current context information from the TV program's meta-data and the STB's local clock, and use the trained algorithm to deduce a best channel that meets the user's expectation. Furthermore, the evolving user viewing behavior will be continuously added to the TV viewing history table and used to train the intelligent selection algorithm further in order to improve its accuracy and meet the user's changing viewing tastes.

It can be used at any kind of channel based entertainment network. It also can be used for both of analog system and digital system.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1-6. (canceled)

7. A device for selecting a start channel at the time of power-on, comprising:
a channel selector for selecting a start channel at the time of power-on from a plurality of channels on the basis of a user's viewing history table; and
a receiver for receiving an input signal corresponding to the start channel selected by the channel selecting means;
wherein the user's viewing history table includes viewing start time, viewing stop time, and channel of a program a user views, which are stored during power-on if a viewing time between the viewing start time and viewing stop time is not less than a predetermined threshold,
wherein, at the time of power-on, if current time falls into the viewing time starting from the latest entry of the user's viewing history table, the channel selecting means selects the corresponding channel to the viewing time as a start channel, if does not, the channel selecting means selects a corresponding channel whose start time has the shortest distance with the current time and is the latest entry of the user's viewing history table.

8. The device according to claim 7, further comprises a storage for storing the data.

9. The device according to claim 7, wherein weekday of a program a user views is further stored in the storage means; and the channel selecting means selects a start channel in the same weekday as the day of the time of power-on.

10. The device according to claim 7, wherein meta-data of a program a user views is further stored in the storage means; and the channel selecting means selects a start channel using the meta-data.

11. A method for selecting a start channel at the time of power-on, comprising:
selecting a start channel at the time of power-on from a plurality of channels on the basis of a user's viewing history table;
receiving an input signal corresponding to the selected start channel to render the start channel;
wherein the user's viewing history table includes viewing start time, viewing stop time, and channel of a program a user views, which are stored during power-on if a viewing time between the viewing start time and viewing stop time is not less than a predetermined threshold,
wherein, at the time of power-on, if current time falls into the viewing time starting from the latest entry of the user's viewing history table, the corresponding channel to the viewing time is selected as a start channel, if does not, a corresponding channel whose start time has the shortest distance with the current time and which is the latest entry of the user's viewing history table is selected as a start channel.

12. The method according to claim 11, wherein a user's viewing history table includes weekday of a program a user views; and selecting a start channel in the same weekday as the day of the time of power on.

13. The method according to claim 11, wherein a user's viewing history table includes meta-data of a program a user views; and selecting a start channel using the meta-data.
